(19) United States
(12) Patent Application Publication
(10) Pub. No.: US 2014/0153868 A1
(43) Pub. Date: Jun. 5, 2014

(54) Optical Bus System

(71) Applicant: HEWLETT-PACKARD DEVELOPMENT COMPANY, L.P., Houston, TX (US)

(72) Inventors: David Martin Fenwick, Chelmsford, MA (US); Richard J. Luebs, Windsor, CO (US); Terrel L. Morris, Garland, TX (US); Duane A. Wegher, Ft. Collins, CO (US); Jeffrey D. Yetter, Loveland, CO (US)

(73) Assignee: HEWLETT-PACKARD DEVELOPMENT COMPANY, L.P., Houston, TX (US)

(21) Appl. No.: 14/174,119

(22) Filed: Feb. 6, 2014

Related U.S. Application Data
(62) Division of application No. 10/980,521, filed on Nov. 3, 2004.

(51) Int. Cl. G02B 6/35

(52) U.S. Cl. CPC G02B 6/354
USPC 385/16

(57) ABSTRACT

Systems are provided having, for example, at least first and second processing units, an optical bus system coupled to the at least first and second processing units, and an optical bus controller coupled to the optical bus system. The optical bus system includes a plurality of optical switches and each optical switch includes, for example, at least a first switch state for directing light in at least a first direction and a second switch state for directing light in at least a second direction. Methods for optical bus communication are also provided.

### BACKGROUND

Computer systems having high communication bandwidths are desirable. In general, bandwidth refers to the amount of information that can be passed through a communication channel over a unit of time. In this regard, most computer systems have discrete digital and/or analog components that are connected to each other over communication channels that are known as busses. By providing such components with the ability to communicate with each other, the components can use their collective capabilities to perform complex tasks such as, for example, playing digital music or digital video or process tasks from a large number of users over a network.

### SUMMARY

In one embodiment, a system is provided having, for example, at least first and second processing units, an optical bus system coupled to the at least first and second processing units, and an optical bus controller coupled to the optical bus system. The optical bus system includes a plurality of optical switches and each optical switch includes, for example, at least a first switch state for directing light in at least a first direction and a second switch state for directing light in at least a second direction.

### BRIEF DESCRIPTION OF THE DRAWINGS

FIG. 1 is a block diagram of one embodiment of a system.

FIG. 2 is a block diagram of a second embodiment of a system.

FIG. 3 is a block diagram of one embodiment of an optical switch array.

FIGS. 4A and 4B illustrate one embodiment of an optical switch.

FIG. 5 illustrates one embodiment of an optical switch array using the optical switch embodiment of FIGS. 4A and 4B.

FIG. 6 illustrates another embodiment of an optical switch.

FIG. 7 illustrates yet another embodiment of an optical switch.

FIGS. 8 and 9 are flow charts illustrating embodiments of bus management logic.

### DETAILED DESCRIPTION OF ILLUSTRATED EMBODIMENTS

The following includes definitions of exemplary terms used throughout the disclosure. Both singular and plural forms of all terms fall within each meaning:

“Signal”, as used herein includes, but is not limited to, one or more electrical signals, analog or digital signals, optical or light (electro-magnetic) signals, one or more computer instructions, a bit or bit stream, or the like.

“Logic”, synonymous with “circuit” as used herein includes, but is not limited to, hardware, firmware, software and/or combinations of each to perform a function(s) or an action(s). For example, based on a desired application or needs, logic may include a software controlled microprocessor, discrete logic such as an application specific integrated circuit (ASIC), or other programmed logic device. Logic may also be fully embodied as software.

“Computer” or “processing unit” as used herein includes, but is not limited to, any programmed or programmable electronic device that can store, retrieve, and process data.

“Optical switch” as used herein includes, but is not limited to, any device or devices that can be controlled so as to direct light from one or more inputs to one or more outputs and can include, for example, movable mirrors, prisms, beam splitters, beam combiners, electrically controlled liquid crystals, plasma cells, and digital light processors.

“Manager” or “manager system” as used herein includes, but is not limited to, any programmed or programmable electronic device that can store, retrieve, and process data for exercising executive, administrative, and supervisory direction or control of other electronic devices. One type of manager is, for example, and optical bus manager that can exercise executive, administrative and supervisory direction or control of data directed to one or more devices connected to an optical bus.

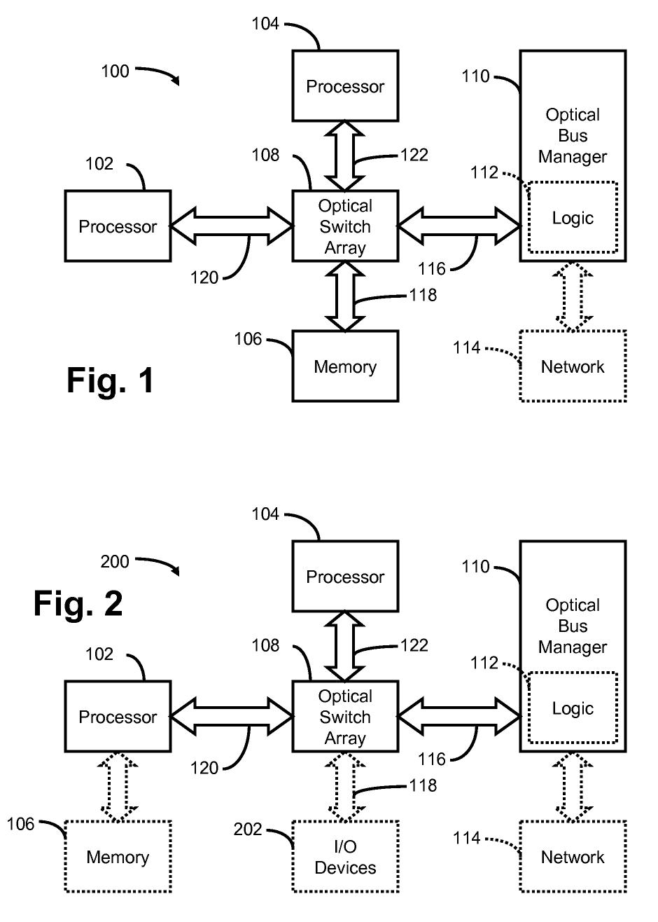

Referring now to FIG. 1, a system 100 is illustrated. The system includes processors for processing units 102 and 104, memory 106, optical switch array 108, optical bus manager 110, and a plurality of optical communication channels 116, 118, 120, and 122. The optical communication channels 116, 118, 120, and 122 may be implemented as a plurality of optical fibers or free-space mediums. Optical bus manager 110 includes logic 112 for managing the state of optical switch array 108. Optical bus manager 110 may further be connected to a network 114 that would allow, for example, a plurality of users to access system 100.

So configured, optical bus manager 110 can control the distribution of tasks and instructions for execution by processing units 102 and 104. For example, processing unit 102 may be dedicated to servicing requests from a first group of users and processing unit 104 may be dedicated to processing requests from a second group of users. Under this arrangement, optical bus manager 110 configures the state of optical switch array 108 to direct data and instructions received from the first group of users to processing unit 102 and from the second group of users to processing unit 104. Furthermore, optical bus manager 110 may configure optical switch array 108 to allow processing units 102 and 104 access to memory 106.

Since optical bus manager 110 can control the distribution of tasks and instructions between the plurality of processing units, optical bus manager 110 can configure the state of optical switch array 108 to direct data and instructions that are destined for a processing unit that may be in a fault condition to a processing unit that is operating properly. Furthermore, optical bus manager 110 can configure the state of optical switch array 108 to direct data and instructions that are destined for a processing unit that is presently tasked with a large number of processing requests to a processing unit that is presently tasked with a relatively lower number of processing requests. In the earlier introduced example, optical bus manager 110 may configure the state of optical switch array 108 to direct data and instructions destined for processing unit 102 to processing unit 104, or vice-versa. In this manner, processing load distribution can be effectively managed to insure that the system is properly loaded given the state of its components.

FIG. 2 illustrates another embodiment of a system 200. System 200 is similar to the system 100 except that processing unit 102 is the gateway through which memory 106 is accessed. Furthermore, optical switch array 108 is connected to one or more I/O devices 202 such as, for example, hard disk drives, CD-ROM drives, DVD drives, cameras, microphones, etc. through optical channel 118. In this embodiment, optical bus manager 110 can further control or manage access to I/O devices 202 by controlling the state of optical switch array 108.

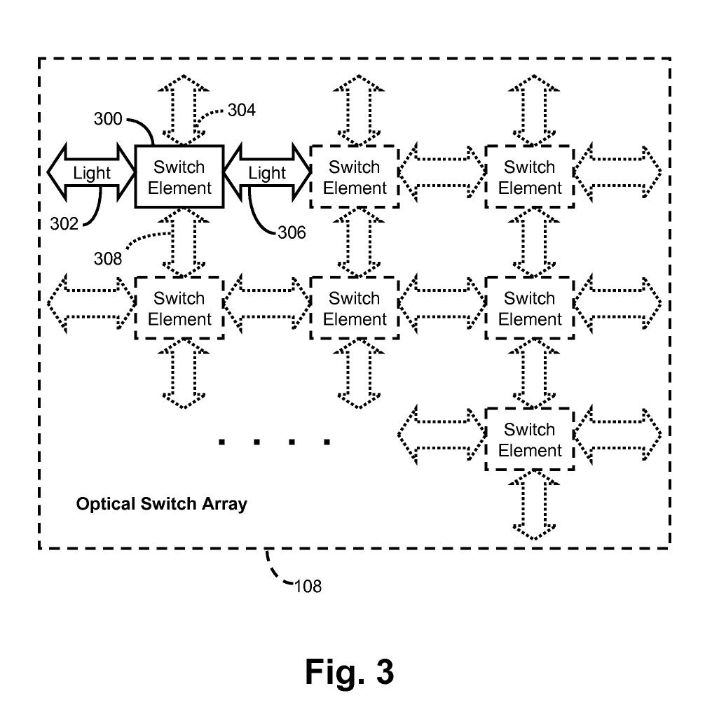

Referring now to FIG. 3, one embodiment of optical switch array 108 is illustrated. Optical switch array 108 may include a plurality of switch elements such as, for example, switch element 300. Switched element 300 is an optical switch having the ability to direct light from one or more inputs to one or more outputs and may be controlled by an external source such as optical bus manager 110. The embodiment of FIG. 3 illustrates a switch element 300 that has a light input 302 and may output light on any one or more of light outputs 304, 306, and 308. Light input 302 may also function as a light output and light outputs 304, 306, and 308 may also function as light inputs. So configured, a switch element may allow light to pass through it or direct or steer the light in a different direction. Hence, a switch element may have a first state that allows light to pass through the switch element and a second state that directs or steers light to a different direction. A switch element may also allow light to pass through to subsequent switch elements or may direct or steer light to subsequent switch elements. Through such an arrangement, optical switch array 108 can direct light from its inputs to its outputs to effect control of data flow.

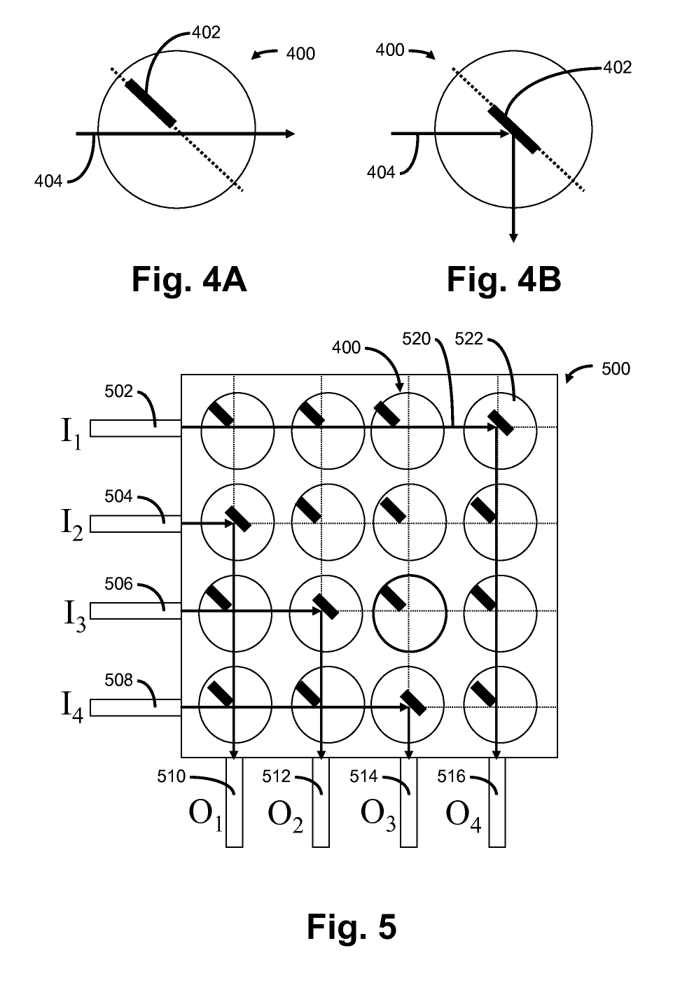

FIGS. 4A and 4B illustrate one embodiment of micro-electromechanical optical switch 400. The general class of optical switches that use mechanical and electrical components to route optical signals are known as micro-electro-mechanical systems (MEMS). MEMS are very small devices that are built on semiconductor chips and are measured in micrometers. There are numerous technologies that take advantage of MEMS in optical switches.

One embodiment of a MEMS optical switch 400 includes micro-mirrors 402. In a two-dimensional implementation, each micro-mirror 402 has two states, an off and an on state. FIGS. 4A and 4B schematically illustrate top views of the potential positions of a two state micro-mirror optical switch 400. The off state allows an optical signal 404 to pass unaltered (FIG. 4A), whereas the on state direct the optical signal 404 to a new path (FIG. 4B). Typically, a micro-mirror 402 is positioned with its reflective surface at a 45 degree angle to the path of the input optical signal 404. This allows for the optical signal 404 to be directed 90 degrees away from its original path. This provides for geometric positioning of components in optical switch 400. The micro-mirror 402 can be moved horizontally, between the on and off positions, by micro gears or electro-magnets. Although FIGS. 4A and 4B illustrate an implementation of a two state micro-mirror optical switch 400, other implementations are possible. For example, optical switch 400 may rotate mirror 402 to intersect the path of optical signal 404 or move mirror 402 vertically to “pop-up” into the path of optical signal 404.

FIG. 5 illustrates one embodiment of an optical switch array 500 using a plurality of optical switches 400. The array 500 further includes a plurality of inputs 502, 504, 506, and 508 and a plurality of outputs 510, 512, 514, and 516. Optical signals 520 enter the array 500 through the inputs and are redirected to the appropriate outputs. In order to redirect a signal, one or more micro-mirrors optical switches 400 are moved to the on position by the optical bus manager or controller 110. FIG. 5 illustrates optical signal 520 entering through input 502 and traveling through several optical switches 400 before being redirected to output 516 by moving the micro-mirror on optical switch 522 into the on position. Similar redirections can be seen for optical signals entering through inputs 504, 506 and 508. While a 4×4 array has been illustrated, it should be noted that the array may be of any size.

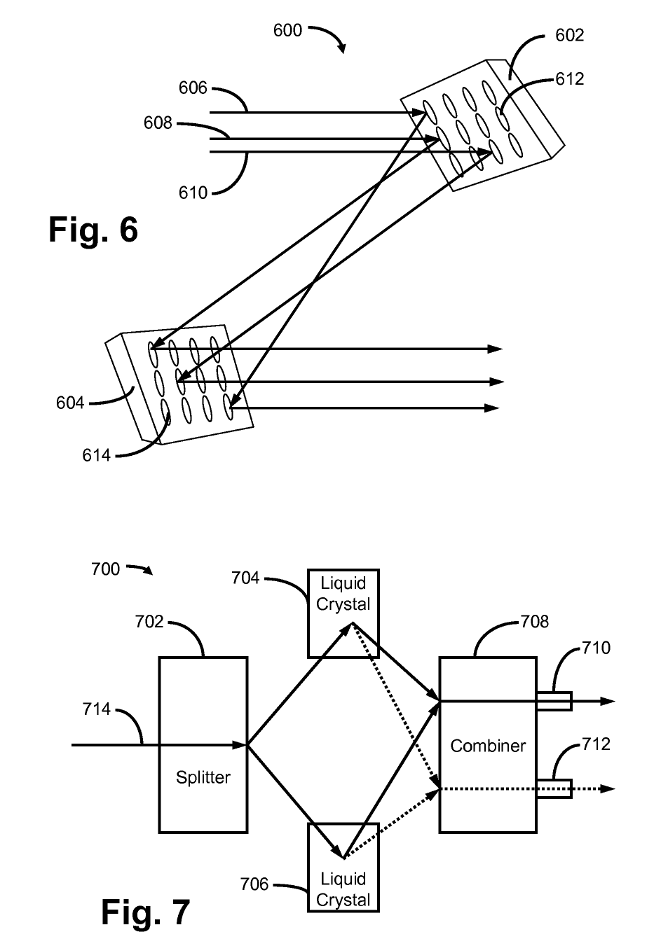

Referring now to FIG. 6, one embodiment of a three-dimensional optical switch 600 is shown. Three dimensional optical switch 600 includes two arrays 602 and 604 of movable micro-mirrors. Generally, the number of micro-mirrors in the first array 602 equals the number of input channels and the number of micro-mirrors in the second array 604 equals the number of output channels. The two arrays 602 and 604 are positioned so that each micro-mirror 612 on the first array 602 has an unimpeded line of sight of each mirror 614 in the second array 604. Each mirror is able to rotate about two axis. This gives the mirror a large number of possible positions. Each mirror in the first array 602 has unique positions that may direct optical signals (e.g., 606, 608, and 610) to each mirror in the second array 604. The second mirror then directs the optical signal to the appropriate output. The rotation or state of the mirrors may be controlled by the optical bus manager or controller 110.

FIG. 7 illustrates yet another embodiment of an optical switch in the form of a liquid crystal optical switch 700. Liquid crystal optical switches have organic materials with a characteristic electric dipole moment that gives its molecules a characteristic mean relative orientation. This orientation is sensitive to a voltage passed across the material. Voltage will re-orient the molecules and change the optical properties of the materials. This physical phenomena may be used to direct optical signals based on the state of a voltage passed through a liquid crystal material.

Liquid crystal optical switch 700 has an input that receives an optical signal 714 through a polarizing beam splitter 702. The beam splitter 702 directs a first beam to liquid crystal 704 and a second beam to liquid crystal 706. The liquid crystals 704 and 706 are oriented in a manner that will pass signal 714 towards output port 710 through a beam combiner 708 if no voltage (state 1) is applied to liquid crystals 704 and 706. If liquid crystals 704 and 706 have a voltage applied across them (state 2), the optical signal 714 will be directed towards output 712. The optical bus manager or controller 110 may be the source of control for the state of liquid crystal optical switch 700.

Other embodiments of controllable optical switches can also be employed in optical switch array 108 including MEMS bubble-based optical switches. These switches include two layers of material. A bottom layer made of silica, which optical signals pass through, and a top layer made of silicon. The bottom layer has paths for each input signal to travel. These paths are intersected by paths that lead to output ports. At each intersection there is a small cavity filled with a liquid having the same index of refraction as the silica. Under normal conditions, the signal passes through the intersection unaffected. There are tiny electrodes in the upper layer that can heat the liquid until it becomes a gas. This change causes the signal to be redirected to the intersecting path and on to the output port.

Another embodiment of the an optical switch includes diffusion and filtering of an optical signal to redirect the signal. A diffusion plate is used to send a broad optical signal, through free space, towards a set of optical signal receivers. Filters attached to the receivers filter out all signals that are not intended for that particular signal receiver.

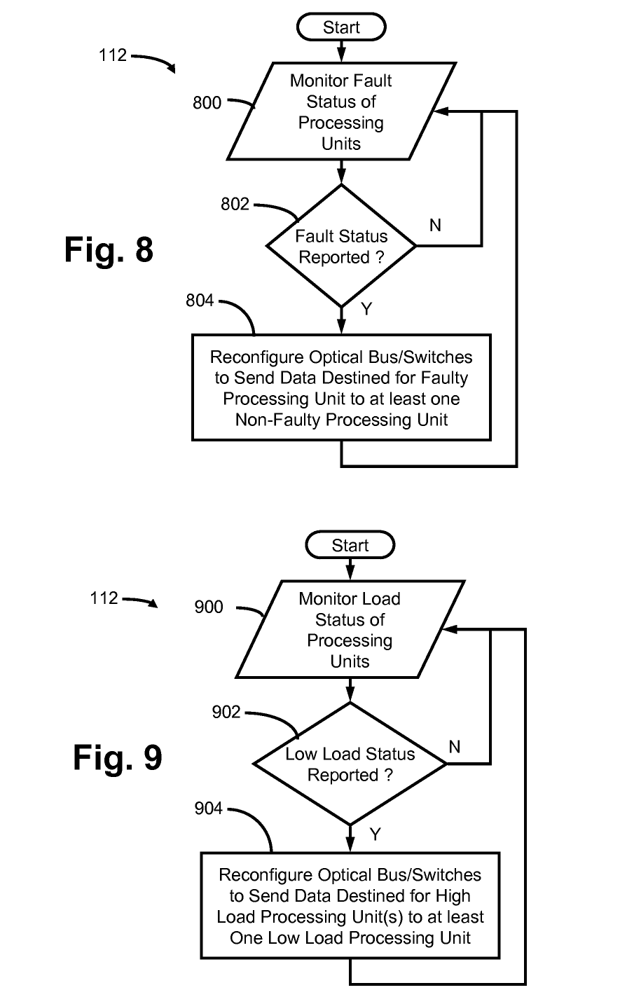

FIG. 8 is one embodiment of a flow diagram illustrating management logic 112. The rectangular elements denote “processing blocks” and represent computer software instructions or groups of instructions. The diamond shaped elements denote “decision blocks” and represent computer software instructions or groups of instructions which affect the execution of the computer software instructions represented by the processing blocks. Alternatively, the processing and decision blocks represent steps performed by functionally equivalent circuits such as a digital signal processor circuit or an application-specific integrated circuit (ASIC). The flow diagram does not depict syntax of any particular programming language. Rather, the flow diagram illustrates the functional information one skilled in the art may use to fabricate circuits or to generate computer software to perform the processing of the system. It should be noted that many routine program elements, such as initialization of loops and variables and the use of temporary variables are not shown.

The logic starts in block 800 where it monitors the fault of status of at least one processing unit. In block 802, the logic tests to determine if the at least one processing unit has reported a fault status. A fault status can include any indication that the processing unit is not operating properly or not fully functional. If a fault status has been reported, the logic proceeds to block 804. In block 804, the logic reconfigures the state of the optical bus switch array 108 to send data destined for the processing unit reporting a fault status to at least one non-faulty processing unit. The logic then loops back to block 800 to start the process again.

FIG. 9 illustrates a flow chart similar to FIG. 8, but is directed to the load status reporting of processing units. In this regard, the logic starts in block 900 where it monitors the load status of at least one processing unit. In block 902, the logic tests to determine if the at least one processing unit has reported a low load status. Alternatively, the logic may also monitor for high load status. Load status is an indication of the usage of a processing unit and may be indicated by the number of tasks or instructions executing or queued, the ratio of idle time to processing time or the number or requests or interrupts that are being or have been serviced by the processing unit. If a low load status has been reported, the logic proceeds to block 904. In block 904, the logic reconfigures the state of the optical bus switch array 108 to send data destined for the processing units reporting a high load status to the at least one processing unit reporting a low load status. The logic then loops back to block 900 to start the process again.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. For example, the number and configuration of switch elements in the optical switch array can be unlimited and optical fibers or free-space communication mediums can be used. Therefore, the invention, in its broader aspects, is not limited to the specific details, the representative apparatus, and illustrative examples shown and described. Accordingly, departures may be made from such details without departing from the spirit or scope of the applicant's general inventive concept.

1-31. (canceled)

32. An optical bus for a multi-processing unit system, the bus comprising:
a plurality of optical switches, each optical switch comprising at least a first switch state for directing light in at least a first direction and a second switch state for directing light in at least a second direction; and
an optical bus controller coupled to the plurality of optical switches.

33. The system of claim 1, wherein:
said plurality of optical switches are arranged in two arrays between a number of inputs and a number of outputs;
in a first of said two arrays of optical switches, each switch corresponds to one of said inputs and has an unimpeded line of sight to each switch in a second of said two arrays of optical switches; and,
in the second array of optical switches, each switch corresponds to one of said outputs and has an unimpeded line of sight to each switch in said first array.

34. The system of claim 2, wherein said optical bus controller coupled to the plurality of optical switches is for individually controlling a state of each optical switch in said array of optical switches so as to selectively create an optical path through said optical bus system between any of said inputs and any of said outputs.

35. The system of claim 1, wherein at least one optical switch comprises a movable member.

36. The system of claim 1, wherein at least one optical switch comprises a voltage controlled movable element.

37. The system of claim 1, wherein at least one optical switch comprises a liquid crystal.

38. The system of claim 1, wherein the optical bus controller is operable to change the state of at least one optical switch.

39. The system of claim 1, wherein the optical bus controller is operable to change the state of at least one optical switch based on monitoring a fault status of a processor receiving data through said optical bus.

40. The system of claim 1, wherein the optical bus controller is operable to change the state of at least one optical switch based on monitoring a load status.

41. The system of claim 1, wherein the optical bus controller configures the optical switches to provide a communication channel to at least one processor of the multi-processing unit system.

42. The system of claim 1, wherein the optical bus controller configures the optical switches to provide a first communication channel to at least a first processing unit and a second communication channel to at least a second processing unit of the multi-processing unit system.

43. The system of claim 11, wherein the optical bus controller configures the optical switches to channel data destined for the first processing unit to the second processing unit.

44. The system of claim 11, further comprising:
at least first and second processing units, each processing unit to store, retrieve and process data, each processing unit communicating with an optical transceiver;
said optical bus optically coupled to an optical transceiver corresponding to each of the at least first and second processing units;
wherein the optical bus controller is operable to change the state of at least one optical switch based on monitoring a fault status of either said first or second processing unit, a fault indicating that a respective processing unit is not fully functional.

45. The system of claim 1, wherein at least one of said optical switches comprises a cavity between two layers of material, said cavity containing a liquid that is selectively heated into a gas to change that optical switch from said first switch state to said second switch state.

46. The system of claim 14, wherein the at least one optical switch comprises a bottom layer made of silica and a top layer made of silicon, said liquid having a same index of refraction as said silica.

47. The system of claim 14, further comprising:
electrodes for selectively heating said liquid into a gas to change that optical switch from said first switch state to said second switch state.

48. The system of claim 16, wherein the electrodes are disposed in an upper layer of said two layers of material.

49. The system of claim 1, wherein the optical bus controller comprises logic for monitoring and changing a distribution of data between at least first and second processing units based on a fault status of either of said first and second processing units.

50. An optical bus for a multi-processing unit system, the bus comprising:
a plurality of optical switches arranged in two arrays between a number of inputs and a number of outputs, each optical switch comprising at least a first switch state for directing light in at least a first direction and a second switch state for directing light in at least a second direction, wherein at least one of said optical switches comprises a cavity between two layers of material, said cavity containing a liquid that is selectively heated into a gas to change that optical switch from said first switch state to said second switch state;
wherein, in a first of said two arrays of optical switches, each switch has an unimpeded line of sight to each switch in a second of said two arrays of optical switches; and
an optical bus controller coupled to the plurality of optical switches for individually controlling a state of each optical switch in said array of optical switches so as to selectively create an optical path through said optical bus system between any of said inputs and any of said outputs.

51. The system of claim 19, further comprising:
at least first and second processing units, each processing unit to store, retrieve and process data, each processing unit communicating with an optical transceiver;
said optical bus being optically coupled to an optical transceiver corresponding to each of the at least first and second processing units;
wherein the optical bus controller is operable to change the state of at least one optical switch based on monitoring a fault status of either said first or second processing unit, a fault indicating that a respective processing unit is not fully functional.
